(19) United States
(12) Patent Application Publication
(10) Pub. No.: US 2020/0324367 A1
(43) Pub. Date: Oct. 15, 2020

(54) METHOD FOR ALIGNING A PLURALITY OF LASER LINES

(71) Applicant: SAINT-GOBAIN GLASS FRANCE, COURBEVOIE (FR)

(72) Inventors: Emmanuel MIMOUN, BOULOGNE-BILLANCOURT (FR); Cécile OZANAM, PALAISEAU (FR)

(21) Appl. No.: 16/760,273

(22) PCT Filed: Oct. 29, 2018
(86) PCT No.: PCT/FR2018/052680

§ 371 Date: Apr. 29, 2020

(30) Foreign Application Priority Data
Oct. 31, 2017 (FR) 1760282

(51) Int. Cl. B23K 26/06; G02B 27/09; B23K 26/067; H01S 3/105; C03C 17/36; C03C 23/00

(52) U.S. Cl. CPC B23K 26/0604; G02B 27/0927; C03C 23/0025; H01S 3/105; C03C 17/3613; B23K 26/067

(57) ABSTRACT

A method includes aligning a plurality i of juxtaposable laser lines in order to form a continuous overall laser line suitable for heat treating a planar substrate capable of being made to move rectilinearly in a first direction, each laser line being formed by a module that emits a laser line onto the surface S of the planar substrate, on which surface a heat treatment is capable of being carried out.

The present invention relates to a method for aligning a plurality of juxtaposable laser lines to form a continuous overall laser line that is uniform in intensity and in width and that is suitable for heat treating a planar substrate. It also relates to a device for aligning laser lines.

Irradiation with laser radiation is at the present time a common method for heat treating the surface of various substrates. The spatial and temporal coherence of laser radiation allows laser beams of small width to be obtained. Focused onto a surface, such a beam allows, in precise zones of the surface of the substrate and over a small depth, high temperatures to be achieved in particularly brief times. This has the advantage of preserving the core of the substrate from any physicochemical conversion liable to be caused by the increase in the temperature of its surface.

This method is in particular employed to heat treat thin coatings deposited on the surface of a mineral or organic substrate, when, for example, it is sought to recrystallize the coatings without degrading the substrate. To this end, laser beams that form lines, called “laser lines”, on the surface to be treated are employed. The heat treatment of the entirety of the surface is obtained by running the substrate under the laser lines, which remain stationary. Examples of use of this method are described in document WO2010142926 with respect to the manufacture of a substrate coated with a stack of thin silver-based layers, or indeed in document WO2010139908 with respect to the manufacture of a substrate coated with thin transparent and electronically conductive layers.

One difficulty in the use of heat-treating methods employing laser lines is the treatment of substrates of large size, for example glass sheets of “jumbo” size (6 m×3.21 m), as then a plurality of elementary laser lines must be combined because a laser line of sufficient length does not exist. The objective is then to achieve the most uniform possible heat treatment over all the width of the surface to be treated, despite the fact that the intensity profile of each of the elementary laser lines is not uniform over its width and its length. The intensity profile is generally Gaussian and varies with the degree of focus. Furthermore, the intensity profile is not perfectly identical from one laser line to the next.

The elementary laser lines are juxtaposed so as to form a continuous overall laser line, such as described in document U.S. Pat. No. 6,717,105 B1. It is possible to find, in the prior art, recommendations as to how to achieve a continuous overall line that is uniform in intensity and in width and that is suitable for a uniform heat treatment. For example, document WO2015059388 provides information on the shape of the linear-power-density profile of each elementary laser line, document WO2013156721 information on the quality factor, the linear power density, the width and the dispersion of the width of the continuous overall laser line, and document WO2017032947 information on the degree of overlap of two adjacent elementary laser lines.

However, the alignment of elementary laser lines as such to form a uniform continuous overall laser line remains a delicate, complex and time-consuming step that monopolizes production tools and requires a certain number of substrates to be sacrificed in trials. Specifically, each elementary laser line is generated by a laser module arranged on a platform placed above the surface of the substrate to be heat treated. Each platform is generally orientable in three directions and by three angles. There are therefore six adjustable parameters per module. In order to illustrate the complexity of the adjustments, it is enough to consider a conventional installation comprising eight modules—the alignment of the eight laser lines then requires forty-eight independent parameters to be adjusted. Alignment is conventionally adjusted using a heuristic “trial and error” procedure that monopolizes the installation and requires a sometimes substantial number of trials on substrates before production is possible.

The present invention solves these problems. One subject thereof is a method for aligning a plurality i of juxtaposable laser lines in order to form a continuous overall laser line suitable for heat treating a planar substrate capable of being made to move rectilinearly in a first direction, each laser line being formed by a module that emits a laser line onto the surface S of the planar substrate, on which surface a heat treatment is capable of being carried out, said method comprising the following steps:
a. acquiring, for each laser line:
   the values of the coordinates Xᵢ, Yᵢ, Zᵢ of the centre of the laser line, the axes X and Y being located in the plane of the surface S, the axis X corresponding to said first direction, the axis Y corresponding to a second direction perpendicular to the first, and the axis Z corresponding to a third direction perpendicular to the plane of the surface S;
   the values of the coordinates Uᵢ, Vᵢ, Wᵢ, corresponding to the angles made by the laser line to the axes X, Y, Z, respectively;
b. computing, with a computer, the intensity profile Iᵢ for each laser line depending on the coordinates Xᵢ, Yᵢ, Zᵢ Uᵢ, Vᵢ, Wᵢ using an intensity function defined beforehand;
c. computing, with a computer, the linear-power-density profile P_{G} corresponding to the sum of the intensities Iᵢ integrated along the axis X for every point along the axis Y;
d. computing, with a computer, the width profile E corresponding to the width of the sum of the intensity profiles Iᵢ along the axis X for every point along the axis Y;
e. comparing, with a computer, the values of the linear-power-density profile P_{G} and of the width profile E to two target values defined beforehand, σ_{P} and σ_{E}, respectively;
f. iterating steps b to e with a new set of values X′ᵢ, Y′ᵤ, Z′ᵢ, U′ᵢ, V′ᵢ, W′ᵢ defined so that in each iteration the values of the linear-power-density profile P_{G} and of the width profile E converge toward the target values σ_{P} and σ_{E}, respectively;
g. adjusting each of the i modules depending on the set of values X′ᵢ, Y′ᵢ, Z′ᵢ, U′ᵢ, V′ᵢ, W′ᵢ thus obtained.

In the context of the present invention, the expression “laser line” designates any laser emission that projects a patch, whether focused or not, having the shape of a line or a strip onto a surface. This shape is generally obtained using an optical device placed on the path of a laser beam, the projection of which onto a surface forms a line. The optical device generally comprises one or more aspherical lenses, such as cylindrical lenses or Powell lenses.

The coordinates Xᵢ, Yᵢ, Zᵢ, Uᵢ, Vᵢ, Wᵢ of each of the laser lines may be acquired by any suitable means. For example it is possible to use an observing device that is movable along the axis Y, such as a camera, and that allows the position and shape of each of the laser lines to be viewed. The laser modules may also comprise display units that display the coordinates of each line in a format readable by an operator or comprise a telecommunication device that transmits them in a format suitable for the execution of steps b to f of the method of the invention.

In most installations comprising laser lines, the intervals of usual values of the coordinates Xᵢ, Yᵢ, Zᵢ, Uᵢ, Vᵢ, Wᵢ are −200 μm to +200 μm, −6 mm to +6 mm, −10 mm to +10 mm, −0.2° to +0.2°, −0.2° to +0.2° and −0.05° to +0.05°, respectively.

Generally, the coordinates Xᵢ, Yᵢ, Zᵢ, Uᵢ, Vᵢ, Wᵢ do not correspond to the spatial coordinates of the movable platforms on which the laser modules are arranged because they are not expressed in the same coordinate system. It is therefore necessary to change coordinate system to pass therebetween.

In step g of the method of the invention, the adjustment of each of the i modules depending on the set of values X′ᵢ, Y′ᵢ, Z′ᵢ, U′ᵢ, V′ᵢ, W′ᵢ may be carried out by any suitable means. For example, the adjustment may be achieved by automatically or manually positioning each of the laser modules after the computation of each of the spatial coordinates thereof depending on the coordinates X′ᵢ, Y′ᵢ, Z′ᵢ, U′ᵢ, V′ᵢ, W′ᵢ, using an operation for changing coordinate system.

The intensity profile of a laser line in the plane transverse to its propagation direction varies depending on the type of lens used to generate it. With cylindrical lenses, the profile is Gaussian in the two directions perpendicular to the direction of propagation of the beams.

With Powell lenses, the profile is essentially Gaussian in the direction of the smallest dimension of the line and perpendicular to the direction of propagation of the beam.

A laser-line beam may also be defined by its width (i.e. its waist), which is denoted w and expressed in units of length, and which corresponds to the distance with respect to the propagation axis at which the intensity is equal to

$$\frac{1}{{e}^{2}}$$

of the maximum intensity, in the plane perpendicular to this axis and in the direction of the smallest dimension of the laser line. The value of the width may vary along the propagation axis. The minimum value of the width is denoted w₀.

In a first embodiment of the invention, the intensity function for the computation of the intensity profile Iᵢ, for each laser line, is a function of Gaussian profile. This embodiment is advantageous for laser lines having an elliptic shape in the direction of their largest dimension.

In the coordinate system adopted in the present invention, the computation, in step b, of the intensity profile Iᵢ for each laser line depending on the coordinates Xᵢ, Yᵢ, Zᵢ, Uᵢ, Vᵢ, Wᵢ is carried out in the two-dimensional plane X, Y at Z=0 corresponding to the surface S of the planar substrate on which a heat treatment is capable of being carried out.

The optical device allowing a laser line to be obtained may also comprise a laser-beam converter, or a converting function, that modifies a Gaussian intensity profile into a so-called “flat-top” or “top-hat” intensity profile, in the dimension of length, the profile in the dimension of width remaining Gaussian. A flat-top intensity profile is a profile that i) has a wide central flat top, or peak, of a high intensity that if not constant preferably fluctuates little, and that ii) has high-gradient edges of rapidly decreasing intensity. The profile is often symmetric. The edges generally have a shape such that they may be geometrically likened to a straight line or the gradient of which is relatively constant over all their length. This gradient is also called “steepness”. A flat-top profile may be characterized by two parameters: the length of the flat-top, which is denoted l, and the steepness of the edges, which is denoted a.

In a second embodiment of the invention, the intensity function for the computation of the intensity profile Iᵢ, for each laser line, is a function of flat-top profile. This embodiment is suitable for laser lines having a flat-top profile in the direction of their largest dimension. In particular, the function of flat-top profile may comprise, as parameters, a minimum beam width, w₀, comprised between 10 μm and 500 μm, a length of the flat top, l, comprised between 1 cm and 300 cm and an edge steepness, a, comprised between 1 mm and 10 mm.

In one embodiment of the invention, in step d, the width of each of the intensity profiles Iᵢ along the axis X is the full width at half maximum. In one alternative embodiment, the width of each of the intensity profiles Iᵢ along the axis X is the width at a height corresponding to an intensity value kJᵢ, where Jᵢ is the maximum intensity value of the profile and k is a real number comprised between 0 and 1.

The laser lines formed on the surface of a planar substrate are generally not perfectly rectilinear. They may undulate slightly. During the alignment of the laser lines, it is thus necessary to take into account the undulations of each laser line in order for the continuous overall laser line formed to have a uniform linear power density at every point on the axis Y. In one embodiment of the invention, for each laser line, the intensity function may comprise a shape function modeling the geometric shape of the laser line.

The following equation is an example of a generic intensity function for computing the flat-top intensity profile Iᵢ, comprising, as parameters, the length of the peak, l, the steepness of the edges a, the minimum width w₀ of the beam and a line shape function F₀:

$$I ( x , y , z ) = \frac{\sqrt{π}}{\sqrt{2} {w}_{0} \sqrt{1 + {( \frac{z}{{Z}_{R}} )}^{2}}} \frac{1}{1 + {e}^{( \vert y \vert - l ) / a}} {e}^{- \frac{2 {( x - {F}_{0} ( y ) )}^{2}}{{w}_{0}^{2} ( 1 + {( \frac{z}{{Z}_{R}} )}^{2} )}}$$

x, y, z are spatial coordinates in the coordinate system of axes X, Y, Z. The function I(x, y, z) is a generic function that generates an intensity profile centered on (0,0,0). The quantity Z_{R} is the Rayleigh length. It is computed using the relationship

$${Z}_{R} = \frac{π {w}_{0}^{2}}{λ {M}^{2}}$$

where λ is the wavelength of the laser beam, and M² is a factor characterizing the divergence of the beam. The factor M² is characteristic of the laser line. It is generally comprised between 1 and 10, and in particular between 1 and 4.

Each laser line, the intensity profile Iᵢ is simply obtained by computing the function I(x′, y′, z′) where x′, y′, z′ are the spatial coordinates obtained after transformation according to the formula:

$$( \begin{matrix}{x}^{′} \\ {y}^{′} \\ {z}^{′}\end{matrix} ) = R ( \begin{matrix}x \\ y \\ z\end{matrix} ) + T$$

Where T is the translation matrix defined by

$$T = ( \begin{matrix}{X}_{i} \\ {Y}_{i} \\ {Z}_{i}\end{matrix} )$$

and R is the translation matrix R=R_{X}(Uᵢ)R_{Y}(Vᵢ)R_{Z}(Wᵢ) in which R_{X}, R_{Y} and R_{Z} are, respectively, the rotation matrices about the axes of the coordinate system X, Y, Z for the Euler angles Uᵢ, Vᵢ, Wᵢ.

Each intensity profile Iᵢ may also be normalized to 1 in order to simplify the computation of the power profiles P_{G}.

For each laser line, the shape function F₀ modeling the geometric shape of the laser line may be established depending on the characteristics of the laser module that generates it. If these characteristics are unknown, the shape function may be any mathematical function capable of reproducing the shape of the laser line emitted onto the surface of the planar substrate. The shape function may be different for each line.

One advantageous shape function is a polynomial Bezier curve defined by at least four control points, two of the four points of which correspond to the two ends of the laser line. The other control points may be advantageously chosen so as to reproduce the shape of the laser line emitted onto the surface of the planar substrate.

These other control points may also be chosen randomly in ranges of values allowing most of the laser lines available for the heat treatment of the planar substrate to be modeled. In particular, the polynomial Bezier curve comprises four control points, two control points of which are randomly chosen to lie at a distance from each end respectively comprised between 10% and 20% of the total length, and at an angle with respect to the axis of the line comprised between −0.1° and +0.1°. This embodiment is advantageous for modeling laser lines the shape of which cannot be determined because suitable acquisition means are lacking. This may for example be the case of an installation for heat treating planar substrates with a continuous overall laser line that does not comprise any acquisition device allowing the geometric shape of each of the juxtaposable laser lines serving to form said continuous overall laser line to be viewed. This is also the case for an installation for which the characteristics of the laser modules that generate the laser lines cannot be determined.

Step f of the method of the invention consists in an iteration of steps b to e with a new set of values X′ᵢ, Y′ᵢ, Z′ᵢ, U′ᵢ, V′ᵢ, W′ᵢ defined so that in each iteration the values of the linear-power-density profile P_{G} and of the width profile E converge toward the target values σ_{P} and σ_{E}, respectively. The target values σ_{P} and σ_{E} are defined beforehand depending on the intrinsic characteristics of each laser line and the precision sought for the alignment. These values are adapted depending on the technical limitations and constraints of the installation.

The target values are generally difficult to achieve exactly. A tolerance threshold below and above the target value is often defined so as to form an interval of values. The target value is then considered to have been reached when the computed value is comprised in this interval. The tolerance threshold may advantageously be plus or minus 10%, in particular 5%, or even 2% of the target value.

There are various mathematical methods allowing, in each iteration, the successive sets of values X′ᵢ, Y′ᵢ, Z′ᵢ, U′ᵢ, V′ᵢ, W′ᵢ allowing the linear-power-density profile P_{G} and the width profile E to be made to converge toward the target values σ_{P} and σ_{E}, respectively, to be defined or computed. In one particular embodiment of the method of the invention, the values X′ᵢ, Y′ᵢ, Z′ᵢ, U′ᵢ, V′ᵢ, W′ᵢ of step f are defined using the least-squares method. The values may also be defined using the Gauss-Newton method or indeed using the gradient method.

All the described embodiments may advantageously be combined.

Another subject of the invention is a computer program containing instructions for executing the steps of the method of any possible embodiment of the invention. Any type of programming language, whether compiled into binary form or directly interpreted, may be used to implement the steps of the method via a sequence of arithmetic or logic instructions executable by a computer or any programmable information-processing system. The computer program may form part of a software package, i.e. a set of executable instructions and/or one or more datasets or databases.

In this respect, another subject of the invention is a computer-readable storage medium on which a computer program containing instructions for executing the steps of the aligning method of the invention is stored. Preferably, this storage medium is a nonvolatile computer memory, for example a semiconductor or magnetic mass storage device (solid-state drive, flash memory). It may be removable from or integrated into the computer that reads the content thereof and that executes the instructions thereof. It may also be integrated into a computer, called the “server”, that is different from the computer that executes the instructions, called the “client”. To execute the instructions contained in the storage medium, the “client” computer may access the memory of the “server” computer by a wired and/or wireless telecommunication means. The “server” computer may also read the storage medium on which the computer program is stored and communicate the instructions in binary form to the “client” computer via any telecommunication means.

It may be advantageous for the storage medium to be a removable medium or a medium that is accessible remotely via a telecommunication means so as to facilitate its dissemination to any place where an aligning method according to the invention is liable to be used.

The invention also relates to a device for aligning a plurality i of juxtaposable laser lines in order to form a continuous overall laser line suitable for heat treating a planar substrate capable of being made to move rectilinearly in a first direction, each laser line being formed by a module that emits a laser line onto the surface S of the planar substrate, on which surface a heat treatment is capable of being carried out, said device comprising the following modules:
a. a module for acquiring, for each laser line:
   the values of the coordinates Xᵢ, Yᵢ, Zᵢ of the centre of the laser line, the axes X and Y being located in the plane of the surface S, the axis X corresponding to said first direction, the axis Y corresponding to a second direction perpendicular to the first, and the axis Z corresponding to a third direction perpendicular to the plane of the surface S;
   the values of the coordinates Uᵢ, Vᵢ, Wᵢ, corresponding to the angles of rotation of the laser line about the axes X, Y, Z, respectively;
b. a module for computing the intensity profile Iᵢ for each laser line depending on the coordinates Xᵢ, Yᵢ, Zᵢ Uᵢ, Vᵢ, Wᵢ using an intensity function defined beforehand;
c. a module for computing the linear-power-density profile P_{G} corresponding to the sum of the intensities Iᵢ integrated along the axis X for every point along the axis Y;
d. a module for computing the width profile E corresponding to the width of each of the intensity profiles Iᵢ along the axis X for every point along the axis Y;
e. a module for comparing the values of the linear-power-density profile P_{G} and of the width profile E to two target values defined beforehand, σ_{P} and σ_{E}, respectively;
f. a module for adjusting each of the i modules depending on the set of values X′ᵢ, Y′ᵢ, Z′ᵢ, U′ᵢ, V′ᵢ, W′ⁱ thus obtained.

In one embodiment of the device of the invention, the acquiring module may comprise an observing device that is movable along the axis Y and arranged in the place of the planar substrate so that its focal plane corresponds to the plane that would be defined by the surface S of said planar substrate it it was present. This device is therefore placed below the zone of the surface of the planar substrate on which the laser lines are formed by the laser modules.

This optical device may, for example, be a camera, preferably a digital camera, suitable for acquiring images of laser lines formed on the surface of a planar substrate given the wavelength of the laser beam used to generate them. The coordinates Xᵢ, Yᵢ, Zᵢ, Uᵢ, Vᵢ, Wᵢ may then be determined using the spatial coordinates of the camera and numerical analysis of the images. The analysis of the images may advantageously be carried out using a computer so as to automate the acquisition of the coordinates Xᵢ, Yᵢ, Zᵢ, Uᵢ, Vᵢ, Wᵢ.

In another embodiment, the acquiring module may comprise a virtual or physical interface for inputting data, such as a computer keyboard, by virtue of which an operator enters the coordinates Xᵢ, Yᵢ, Zᵢ, Uᵢ, Vᵢ, Wᵢ for each of the laser lines. The operator may have read the coordinates from a display device on which the laser modules display the Xᵢ, Yᵢ, Zᵢ, Uᵢ, Vᵢ, Wᵢ of the laser line that it forms on the surface of the substrate. The input interface is preferably connected by any wireless or wired telecommunication means to the first computing module of step b of the aligning device of the invention.

The acquiring module may also comprise a wired or wireless telecommunication device that transmits the coordinates Xᵢ, Yᵢ, Zᵢ, Uᵢ, Vᵢ, Wᵢ of each of the laser lines from an optical device for observing the laser lines to the first computing module of step b of the aligning method or indeed between said computing module and the laser modules.

The computing modules b to d of the aligning device of the invention may advantageously comprise one or more computing units. Central processing units comprise computing units. Central processing units are generally integrated into computers, which also comprise a set of other electronic components, such as input-output interfaces, volatile and/or non-volatile storage systems and buses, which are required to transfer data between the central processing units and to communicate with exterior systems, here the various modules.

The comparing module may comprise one or more computing units similar to those of the computing modules.

The number and computing speed of the computing units, and a fortiori of the central processing units, required to execute the computing steps of the method of the invention may be adjusted depending on the number of laser lines. By way of example, for four laser lines of 400 mm length and 60 μm width, a single central processing unit with a clock frequency of 1.90 GHz may be sufficient.

The computed coordinates X′ᵢ, Y′ᵢ, Z′ᵢ, U′ᵢ, V′ᵢ, W′ᵢ may generally not correspond to the spatial coordinates of the movable platforms on which the laser modules are arranged because they are not expressed in the same coordinate system. It is therefore necessary to change coordinate system to pass therebetween. To this end, the adjusting module may comprise a coordinate-converting sub-module for changing coordinate system, so as to compute the spatial coordinates that the platforms must adopt for the laser lines that they generate to have the coordinates X′ᵢ, Y′ᵢ, Z′ᵢ, U′ᵢ, V′ᵢ, W′ᵢ, respectively. This sub-module may be any programmable information-processing system possessing a readable storage medium on which is stored a computer program containing executable instructions allowing the change of coordinate system to be computed using, for example, a transformation matrix. Advantageously, the adjusting module may incorporate a telecommunication means suitable for transmitting the transformed spatial coordinates to the movable platforms. It may also comprise a digital data converter, if the format of the coordinates calculated by the comparing module must be converted into a format that is readable or executable by the movable platforms.

In one embodiment of the invention, the aligning device furthermore comprises a module for graphically displaying the power and width profiles P_{G} and E. The display module may preferably comprise a graphical display device for displaying human-readable information. Such a module is advantageous for checking that the laser lines are actually aligned into a continuous overall line, and that the properties with respect to intensity and width are suitable for the heat treatment of the planar substrate the conversion of which is desired. The display device may also display other information such as the width, length, and the coordinates X′ᵢ, Y′ᵢ, Z′ᵢ, U′ᵢ, V′ᵢ, W′ᵢ of each of the laser lines. It may also indicate the coordinates of the optical device for observing the laser lines.

All of the computing and comparing modules may be virtual modules. By way of example, they may be modules instantiated in the form of objects by a computer program or a software package on the basis of classes in the random-access memory, optionally assisted by a virtual memory, of a computer. The computer may comprise a plurality of central processing units, storage media and input-output interfaces. It advantageously comprises telecommunication means for communicating with the acquiring and adjusting modules.

In some embodiments of the aligning device of the invention, all of the acquiring, computing and adjusting modules are virtual modules. The aligning device may then comprise a computer equipped with one or more central processing units, at least one nonvolatile memory, at least one volatile memory, and input-output interfaces allowing digital data to be exchanged with exterior systems. These interfaces may comprise a physical or virtual interface for inputting data, such as a computer keyboard, by virtue of which an operator enters the coordinates Xᵢ, Yᵢ, Zᵢ, Uᵢ, Vᵢ, Wᵢ, a wired or wireless telecommunication device in communication with the laser modules or the movable platforms on which they are arranged, and/or a display device.

Preferably, the display device is a human-machine graphical interface, for example a digital display, displaying human-readable information. It may display, in graphical form, the profiles of the intensities Iᵢ, of the sum P_{G} and of the width E. The device may also display other information such as the width, the length, and the coordinates X′ᵢ, Y′ᵢ, Z′ᵢ, U′ᵢ, V′ᵢ, W′ᵢ of each of the laser lines, and the spatial coordinates of the platforms on which the laser modules are arranged.

The aligning method of the invention may advantageously be implemented in a process for manufacturing a planar substrate comprising a coating heat treated by juxtaposable laser lines forming a continuous overall laser line. The manufacturing process comprises:
i) a step in which a planar substrate comprising a coating capable of being heat treated is provided;
ii) a step of aligning juxtaposable laser lines using the aligning method according to the invention;
iii) a step of heat treating the coating using the continuous overall line formed by the laser lines thus aligned.

The substrate may for example be a mineral or organic substrate. Some or all of the surface of one of the main faces thereof is coated with a coating formed of a layer or of a stack of a plurality of layers. These layers may be of organic, metal or mineral nature.

In particular, the manufacturing process is suitable for processing glass sheets of large size, for example jumbo sheets (6 m×3.21 m), coated with a stack of thin layers of dielectric and/or metal nature. For example, the glass sheet may be a sheet of soda-lime glass on which a stack comprising one or more dielectric and/or functional metal layers has been deposited.

Said manufacturing process may be implemented at a manufacturing site different from that at which the substrate is produced and/or that at which it is coated with a coating.

In an old installation in which planar substrates are heat treated with a continuous overall laser line formed by a plurality of juxtaposable laser lines, incompatibility between the hardware or software of existing and new devices often prevents any interoperation of these devices. In such an installation, it is possible that the method and/or device of the invention to not suitably operate with existing devices. The method and device of the invention may be adapted.

In this context, the invention also relates to a method for simulating alignment of a plurality i of juxtaposable laser lines in order to form a continuous overall laser line:
a. a step of simulating a plurality i of modules each emitting a laser line onto the surface S of a planar substrate capable of being made to move rectilinearly in a first direction;
b. a step of generating, for each laser line,
   the values of the coordinates Xᵢ, Yᵢ, Zᵢ of the centre of the laser line, the axes X and Y being located in the plane of the surface S, the axis X corresponding to said first direction, the axis Y corresponding to a second direction perpendicular to the first, and the axis Z corresponding to a third direction perpendicular to the plane of the surface S;
   the values of the coordinates Uᵢ, Vᵢ, Wᵢ, corresponding to the angles of rotation of the laser line about the axes X, Y, Z, respectively;
   each of the values of the coordinates Xᵢ, Yᵢ, Zᵢ, Uᵢ, Vᵢ, Wᵢ being generated randomly in an interval of values defined beforehand;
c. a step of aligning the juxtaposable laser lines using a method for aligning laser lines according to the invention;
d. a step of graphically representing the continuous overall laser line thus simulated.

The advantage of this method is that it makes it possible to simulate the effect of modification of the coordinates of each of the laser lines on the alignment without it being necessary to be connected to the existing installation. The method is of pedagogic interest. It allows a human operator who wants to align juxtaposable laser lines into a continuous overall line to understand the relationship between the modification of one of the coordinates of a laser line and the alignment. The method is also of economic interest since the operator does not monopolize the installation for alignment trials and saves time during the alignment of the laser modules of the installation by virtue of the knowledge that he has acquired with regard to optimal adjustment of the modules. Furthermore, it is possible to simulate a laser-line configuration similar to that used on the existing installation, in order to determine which module coordinates must be adjusted and how they must be adjusted.

In step b of the simulating method of the invention, each of the values of the coordinates Xᵢ, Yᵢ, Zᵢ, Uᵢ, Vᵢ, Wᵢ is randomly generated in an interval of values defined beforehand. This interval of values may correspond to the interval of values that the coordinates Xᵢ, Yᵢ, Zᵢ, Uᵢ, Vᵢ, Wᵢ of the laser lines of an existing installation are actually able to take. It may also correspond to the interval of values liable to be obtained with modules installation of which is envisioned. The latter embodiment is particularly advantageous because it allows operators to be trained in the alignment of laser lines before the new installation is operational.

The coordinates Xᵢ, Yᵢ, Zᵢ, Uᵢ, Vᵢ, Wᵢ may be randomly generated in the respective following intervals of values: −200 μm to +200 μm, −6 mm to +6 mm, −10 mm to +10 mm, −0.2° to +0.2°, −0.2° to +0.2° and −0.05° to +0.05°.

In step c of the simulating method, the successive sets of values X′ᵢ, Y′ᵢ, Z′ᵢ, U′ᵢ, V′ᵢ, W′ᵢ allowing the linear-power-density profile P_{G} and the width profile E to be made to converge towards the target values σ_{P} and σ_{E}, respectively, may also be defined manually using a heuristic “trial and error” procedure. This embodiment is advantageous for pedagogic purposes.

In step d of the simulating method, the simulated continuous overall laser line is preferably graphically represented using a graphical interface. The graphically represented information are preferably human-readable. Other information may advantageously be graphically represented, for example, the power profile P_{G}, the width profile L and information relating to the number, length and width of the laser lines.

Another subject of the invention is a device for simulating alignment of a plurality i of juxtaposable laser lines in order to form a continuous overall laser line, comprising:
a. a module for simulating a plurality i of modules each emitting a laser line onto the surface S of a planar substrate capable of being made to move rectilinearly in a first direction;
b. a module for generating, for each laser line,
   the values of the coordinates Xᵢ, Yᵢ, Zᵢ of the centre of the laser line, the axes X and Y being located in the plane of the surface S, the axis X corresponding to said first direction, the axis Y corresponding to a second direction perpendicular to the first, and the axis Z corresponding to a third direction perpendicular to the plane of the surface S;
   the values of the coordinates Uᵢ, Vᵢ, Wᵢ, corresponding to the angles of rotation of the laser line about the axes X, Y, Z, respectively;
   each of the values of the coordinates Xᵢ, Yᵢ, Zᵢ, Uᵢ, Vᵢ, Wᵢ being generated randomly in an interval of values defined beforehand;
c. a device for aligning the juxtaposable laser lines using a method for aligning laser lines according to the invention;
d. a module for graphically representing the continuous overall laser line thus simulated.

The generating and simulating modules may advantageously comprise one or more computing units. Central processing units comprise computing units. Central processing units are generally integrated into computers, which also comprise a set of other electronic components, such as input-output interfaces, volatile and/or non-volatile storage systems and buses, which are required to transfer data between the central processing units and to communicate with exterior systems, here the various modules.

The number and computing speed of the computing units, and a fortiori of the central processing units, required to execute the computing steps of the method of the invention may be adjusted depending on the number of laser lines. By way of example, for four laser lines of 400 mm length and 60 μm width, a single central processing unit with a clock frequency of 1.9 GHz may be sufficient.

All of the modules of the simulating device are virtual modules. By way of example, they may be modules instantiated in the form of objects by a computer program or a software package on the basis of classes in the random-access memory, optionally assisted by a virtual memory, of a computer. The computer may comprise a plurality of central processing units, storage media and input-output interfaces. It advantageously comprises telecommunication means for communicating with the acquiring and adjusting modules.

The graphical representation module is preferably a human-readable graphical interface via a human-machine dialogue device. It may be a component of the computer in which the virtual modules of the simulating device are instantiated.

The features and advantages of the invention are illustrated by the figures and examples described below.

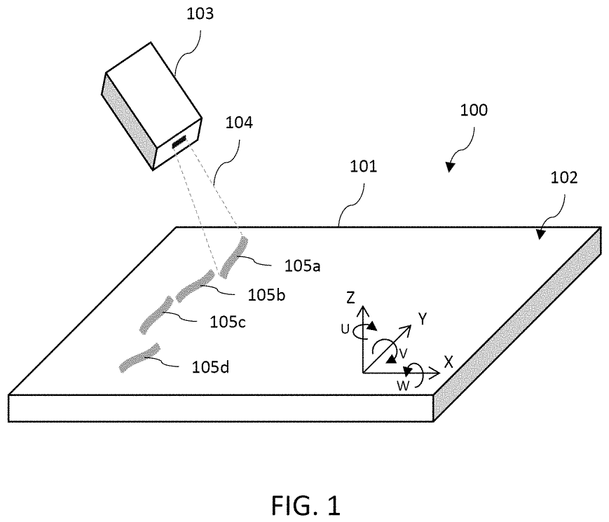

FIG. 1 is a schematic representation of an illustrative example of a process for heat treating a planar substrate capable of being made to move rectilinearly, using four juxtaposable laser lines, each laser line being formed by a module that emits a laser line onto the surface S of the planar substrate, on which surface a heat treatment is capable of being carried out.

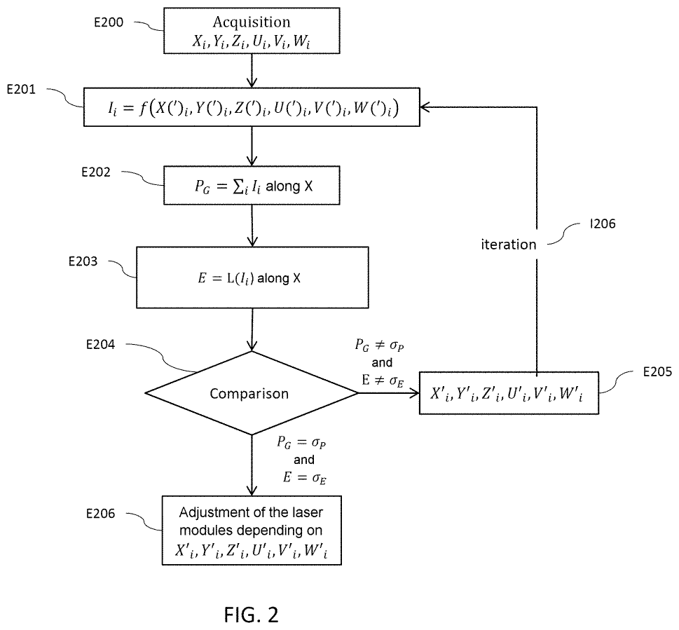

FIG. 2 is a graphical representation, taking the form of a chart, of the aligning method of the invention.

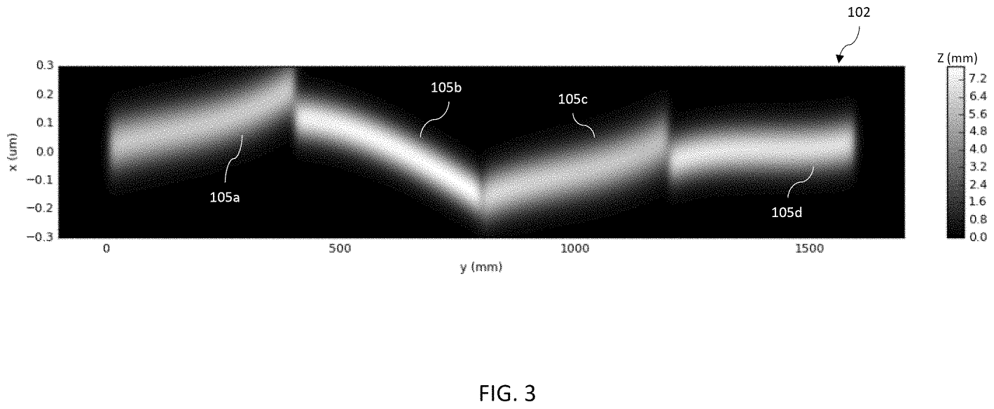

FIG. 3 is a graphical representation of four juxtaposable and non-aligned laser lines formed on a planar substrate.

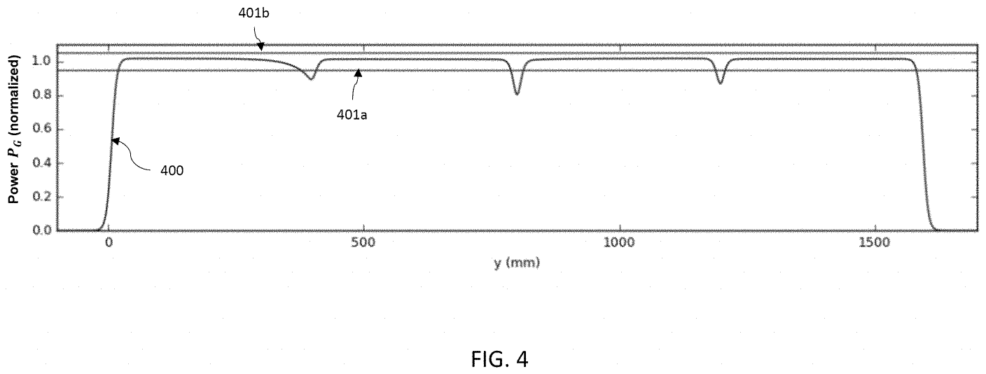

FIG. 4 is a graphical representation of the linear-power-density profile P_{G} along the axis X for every point along the axis Y for the four laser lines of FIG. 3.

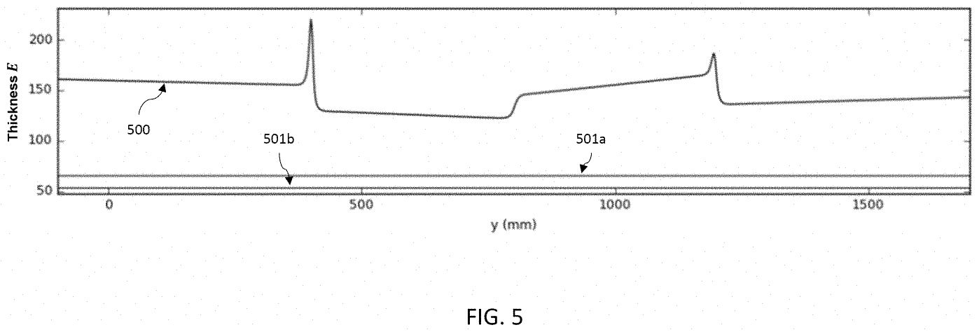

FIG. 5 is a graphical representation of the width profile E corresponding to the full width at half maximum of each of the intensity profiles Iᵢ along the axis X for every point along the axis Y, for all of the four laser lines of FIG. 3.

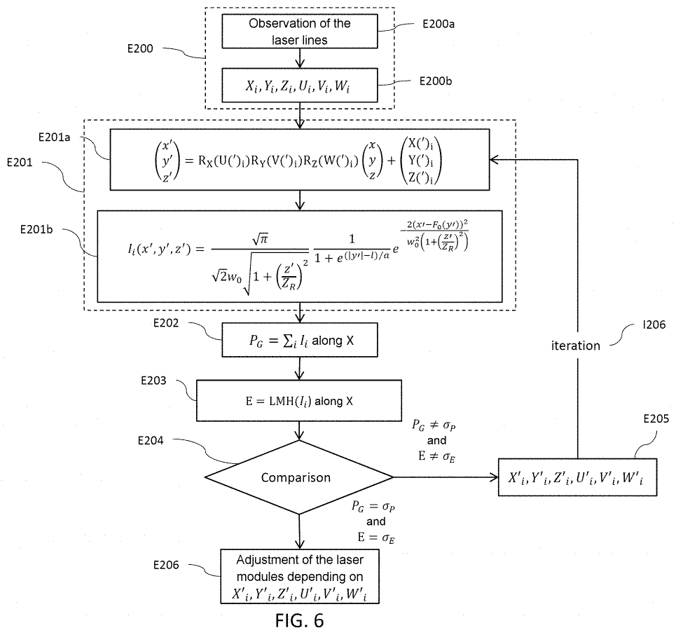

FIG. 6 is a graphical representation, taking the form of a chart, of one embodiment of the aligning method of the invention.

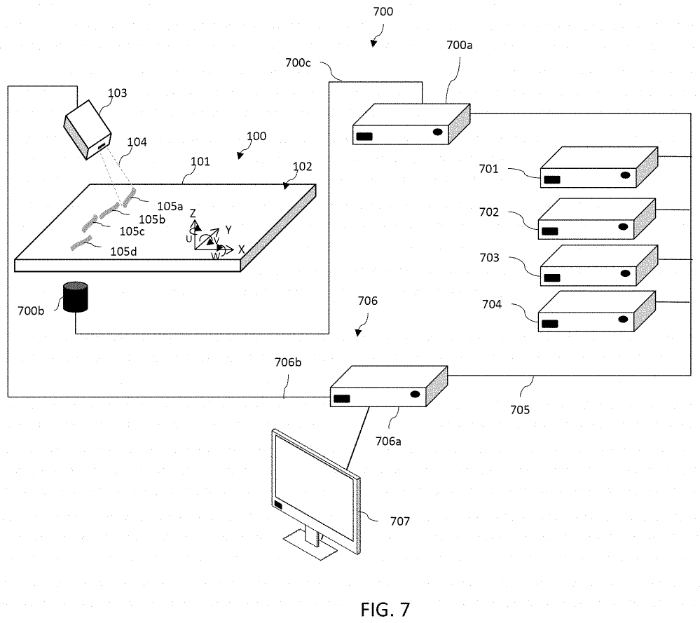

FIG. 7 is a schematic representation of a first embodiment of an aligning device of the invention.

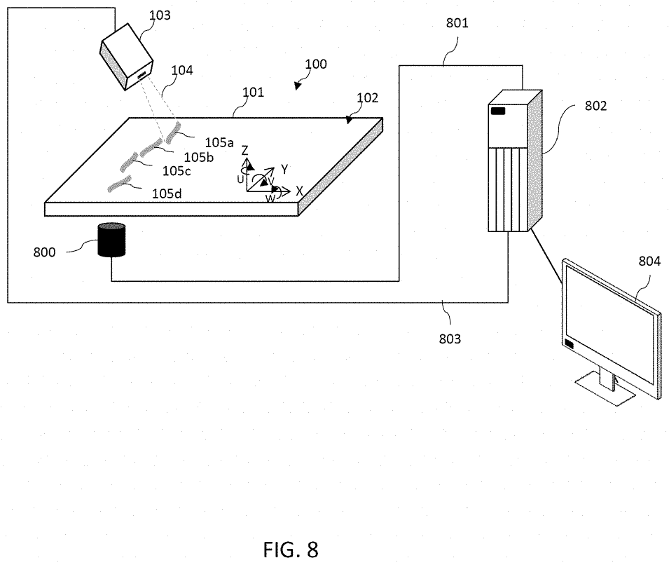

FIG. 8 is a schematic representation of a second embodiment of an aligning device of the invention.

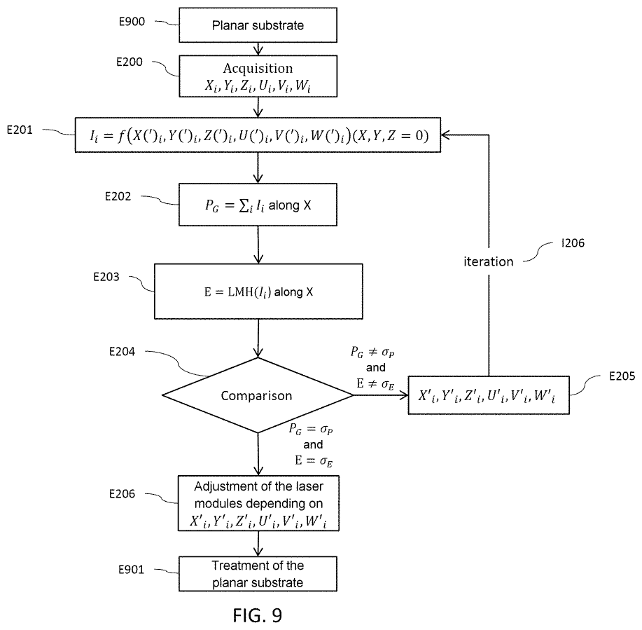

FIG. 9 is a graphical representation, taking the form of a chart, of a process for manufacturing a planar substrate comprising a coating heat treated by juxtaposable laser lines forming a continuous overall laser line.

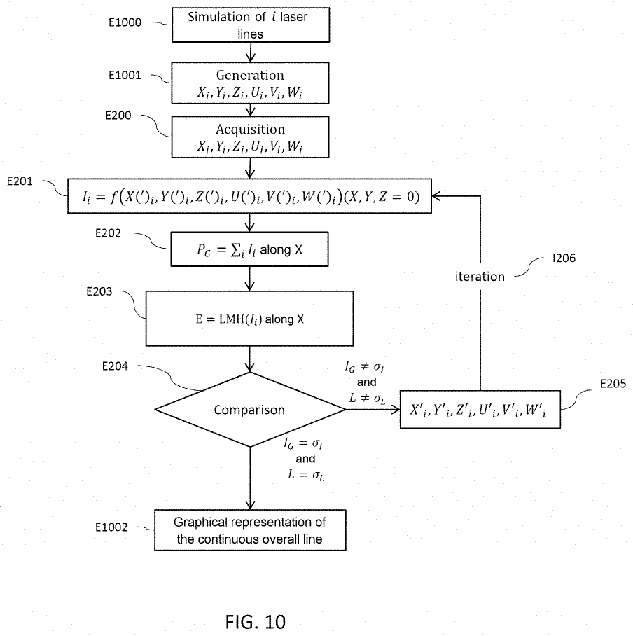

FIG. 10 is a graphical representation, taking the form of a chart, of the simulating method of the invention.

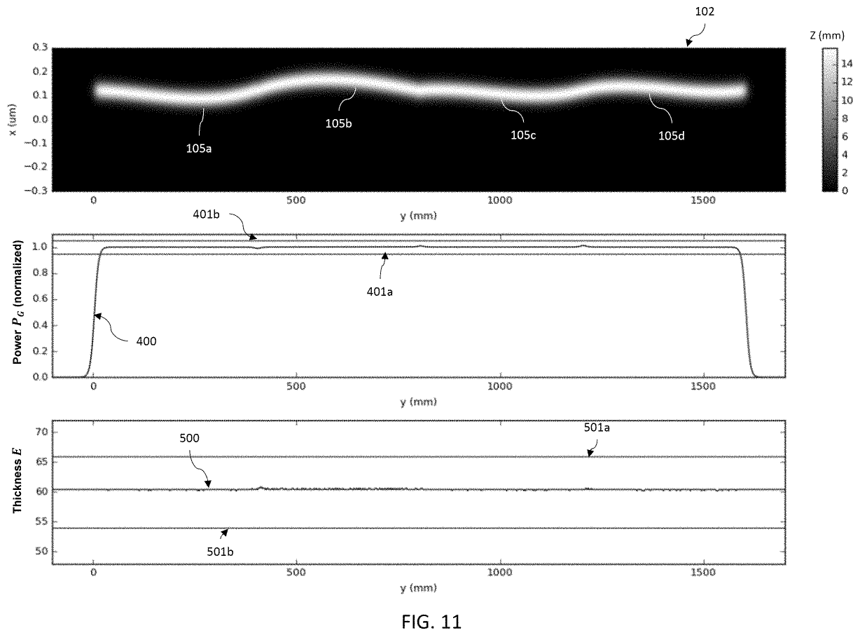

FIG. 11 is a graphical representation of the four laser lines of FIG. 3 and of the power and width profiles P_{G} and E along the axis X for every point along the axis Y after an alignment using the aligning method of the invention.

FIG. 1 schematically shows an illustrative example of a process 100 for heat treating a planar substrate 101 capable of being made to move rectilinearly, using four juxtaposable laser lines 105a-d, each laser line 105a-d being formed by a module 103 that emits a laser line 105a-d onto the surface S 102 of the planar substrate 101, on which surface a heat treatment is capable of being carried out. In this example, for the sake of simplification, a single laser module 103 has been shown. There are generally as many laser lines as there are laser modules.

The aligning method of the invention is graphically represented, in the form of a chart, in FIG. 2. The method for aligning a plurality i of juxtaposable laser lines in order to form a continuous overall laser line suitable for heat treating a planar substrate capable of being made to move rectilinearly in a first direction, each laser line being formed by a module that emits a laser line onto the surface S of the planar substrate, on which surface a heat treatment is capable of being carried out, comprises the following steps:
a. acquiring E200, for each laser line:
   the values of the coordinates Xᵢ, Yᵢ, Zᵢ of the centre of the laser line, the axes X and Y being located in the plane of the surface S, the axis X corresponding to said first direction, the axis Y corresponding to a second direction perpendicular to the first, and the axis Z corresponding to a third direction perpendicular to the plane of the surface S;
   the values of the coordinates Uᵢ, Vᵢ, Wᵢ, corresponding to the angles made by the laser line to the axes X, Y, Z, respectively;
b. computing E201, with a computer, the intensity profile I=f(X(′)ᵢ, Y(′)ᵢ, Z(′)ᵢ, U(′)ᵢ, V(′)ᵢ, W(′)ᵢ) for each laser line depending on the coordinates Xᵢ, Yᵢ, Zᵢ, Uᵢ, Vᵢ, Wᵢ using an intensity function defined beforehand;
c. computing E202, with a computer, the linear-power-density profile P_{G} corresponding to the sum P_{G}=ΣᵢIᵢ of the intensities Iᵢ integrated along the axis X for every point along the axis Y;
d. computing E203, with a computer, the width profile E=L(Iᵢ) corresponding to the width of the each of the intensity profiles Iᵢ along the axis X for every point along the axis Y;
e. comparing E204, with a computer, the values of the linear-power-density profile P_{G} and of the width profile E to two target values defined beforehand, σ_{P} and σ_{E}, respectively;
f. iterating I206 steps b to e with a new set of values X′ᵢ, Y′ᵢ, Z′ᵢ, U′ᵢ, V′, W′ᵢ E205 defined so that in each iteration the values of the linear-power-density profile P_{G} and of the width profile E converge toward the target values σ_{P} and σ_{E}, respectively;
g. adjusting E206 each of the i modules depending on the set of values X′ᵢ, Y′ᵢ, Z′ᵢ, U′ᵢ, V′ᵢ, W′ᵢ thus obtained.

In step E203, the function L(I) computes the width of each of the intensity profiles Iᵢ along the axis X for every point along the axis Y.

FIG. 3 graphically shows four juxtaposable and non-aligned laser lines 150a-d formed on a planar substrate 102. Each of the lines differs from the other lines in its intensity profile Iᵢ, its shape and its coordinates Xᵢ, Yᵢ, Zᵢ, Uᵢ, Vᵢ, Wᵢ.

FIG. 4 is a graphical representation of the linear-power-density profile 400, P_{G} Σᵢ Iᵢ, i.e of the sum of the intensities Iᵢ along the axis X for every point along the axis Y for the four laser lines of FIG. 3. The horizontal lines 401a and 401b represent the thresholds at 5% about the target value up. The target value is here set to 1 because the intensities Iᵢ have been normalized.

FIG. 6 shows the width profile E 500 corresponding to the full width at half maximum of each of the intensity profiles Iᵢ along the axis X for every point along the axis Y, for the four laser lines of FIG. 3. The horizontal lines 501a and 501b represent thresholds at 10% about the target value σ_{E}.

One embodiment of the method of the invention is shown in FIG. 6. The method comprises the following steps:
a. the acquisition E200, for each laser line, comprises the following substeps:
   i. observing E200a the laser lines;
   ii. measuring E200b:
      the values of the coordinates Xᵢ, Yᵢ, Zᵢ of the centre of the laser line, the axes X and Y being located in the plane of the surface S, the axis X corresponding to said first direction, the axis Y corresponding to a second direction perpendicular to the first, and the axis Z corresponding to a third direction perpendicular to the plane of the surface S;
      the values of the coordinates Uᵢ, Vᵢ, Wᵢ, corresponding to the angles made by the laser line to the axes X, Y, Z, respectively;
b. computing E201, with a computer, the intensity profile Iᵢ for each laser line depending on the coordinates Xᵢ, Yᵢ, Zᵢ, Uᵢ, Vᵢ, Wᵢ using an intensity function of flat-top profile defined beforehand; step E201 comprises the following substeps:
   i. computing E201a the coordinates x′, y′, z′ using the formula

$$( \begin{matrix}{x}^{′} \\ {y}^{′} \\ {z}^{′}\end{matrix} ) = {R}_{X} ( {U {(}^{′} )}_{i} ) {R}_{Y} ( {V {(}^{′} )}_{i} ) {R}_{Z} ( {W {(}^{′} )}_{i} ) ( \begin{matrix}x \\ y \\ z\end{matrix} ) + ( \begin{matrix}{X {(}^{′} )}_{i} \\ {Y {(}^{′} )}_{i} \\ {Z {(}^{′} )}_{i}\end{matrix} )$$

where R_{X}, R_{Y} et R_{Z} are the rotation matrices about the axes of the coordinate system X, Y, Z for the Euler angles U(′)ᵢ, V(′)ᵢ, W(′)ᵢ, respectively;
ii. computing E201b the intensities Iᵢ using the formula:

$${I}_{i} ( {x}^{′} , {y}^{′} , {z}^{′} ) = \frac{\sqrt{π}}{\sqrt{2} {w}_{0} \sqrt{1 + {( \frac{z ′}{{Z}_{R}} )}^{2}}} \frac{1}{1 + {e}^{( \vert y ′ \vert - l ) / a}} {e}^{- \frac{2 {( x ′ - {F}_{0} ( y ′ ) )}^{2}}{{w}_{0}^{2} ( 1 + {( \frac{z ′}{{Z}_{R}} )}^{2} )}}$$

c. computing E202, with a computer, the linear-power-density profile P_{G}=ΣᵢIᵢ integrated along the axis X for every point along the axis Y;
d. computing E203, with a computer, the width profile E corresponding to the full width at half maximum E=LMH(Iᵢ) of the each of the intensity profiles Iᵢ along the axis X for every point along the axis Y;
e. comparing E204, with a computer, the values of the linear-power-density profile P_{G} and of the width profile E to two target values defined beforehand, σ_{P} and σ_{E}, respectively;
f. iterating I206 steps b to e with a new set of values X′ᵢ, Y′ᵢ, Z′ᵢ, U′ᵢ, V′ᵢ, W′ᵢ E205 defined so that in each iteration the values of the linear-power-density profile P_{G} and of the width profile L converge toward the target values σ_{P} and σ_{E}, respectively;
g. adjusting E206 each of the i modules depending on the set of values X′ᵢ, Y′ᵢ, Z′ᵢ, U′ᵢ, V′ᵢ, W′ᵢ thus obtained.

A first embodiment of a device of the invention is schematically shown in FIG. 7. The device for aligning a plurality i of juxtaposable laser lines in order to form a continuous overall laser line suitable for heat treating a planar substrate capable of being made to move rectilinearly in a first direction, each laser line being formed by a module that emits a laser line onto the surface S of the planar substrate, on which surface a heat treatment is capable of being carried out, comprises the following modules:
a. a module 700 for acquiring, for each laser line:
   the values of the coordinates Xᵢ, Yᵢ, Zᵢ of the centre of the laser line, the axes X and Y being located in the plane of the surface S, the axis X corresponding to said first direction, the axis Y corresponding to a second direction perpendicular to the first, and the axis Z corresponding to a third direction perpendicular to the plane of the surface S;
   the values of the coordinates Uᵢ, Vᵢ, Wᵢ, corresponding to the angles of rotation of the laser line about the axes X, Y, Z, respectively;
b. a module 701 for computing the intensity profile Iᵢ for each laser line depending on the coordinates Xᵢ, Yᵢ, Zᵢ, Uᵢ, Vᵢ, Wᵢ using an intensity function defined beforehand;
c. a module 702 for computing the linear-power-density profile P_{G} corresponding to the sum of the intensities Iᵢ integrated along the axis X for every point along the axis Y;
d. a module 703 for computing the width profile E corresponding to the width of each of the intensity profiles Iᵢ along the axis X for every point along the axis Y;
e. a module 704 for comparing the values of the linear-power-density profile P_{G} and of the width profile E to two target values defined beforehand, σ_{P} and σ_{E}, respectively;
f. a module 706 for adjusting each of the i modules depending on the set of values X′ᵢ, Y′ᵢ, Z′ᵢ, U′ᵢ, V′ᵢ, W′ᵢ thus obtained.

The acquiring module 700 comprises a device 700b for observing the laser lines. This observing device, which is movable along the axis Y, is arranged in the place of the planar substrate so that its focal plane corresponds to the plane that would be defined by the surface S of said planar substrate if it was present. In the figure, for the sake of simplicity, the observing device 700b has been placed beside the substrate.

The observing device 700b transmits images coded in binary form to a processing sub-module 700a using a telecommunication means 700c. The sub-module 700a processes the transmitted images so as to acquire the coordinates Xᵢ, Yᵢ, Zᵢ, Uᵢ, Vᵢ, Wᵢ of each of the laser lines. The coordinates are then transmitted to the module 701 by any suitable telecommunication means 705. Advantageously, the telecommunication means 705 may be a single means used to transmit binary digital information between all the modules.

The computing modules 701 to 703 and the comparing module 704 are computers comprising one or more central processing units. The adjusting module 706 comprises a processing unit 706a, for example a computer, allowing instructions to be communicated to the holders of the laser modules 103 so as to adjust them depending on the computed sets of values X′ᵢ, Y′ᵢ, Z′ᵢ, U′ᵢ, V′ᵢ, W′ᵢ. The spatial coordinates of the laser modules are computed depending on the coordinates X′ᵢ, Y′ᵢ, Z′ᵢ, U′ᵢ, V′ᵢ, W′ᵢ using a operation for changing coordinate system.

The instructions are communicated using a suitable telecommunication means 706b. Advantageously, the adjusting module may comprise a display device 707 allowing information to be communicated to an operator in a human-readable format. Examples of information are the power and width profiles P_{G} and E and information relating to the number and to the length of the laser lines.

FIG. 8 is a schematic representation of a second embodiment of a device of the invention. In this embodiment, the modules 701 to 704 and the sub-modules 700a and 706a are virtual modules instantiated in the form of objects by a computer program or a software package on the basis of classes in the random-access memory, optionally assisted by a virtual memory, of a computer 802. The computer may comprise a plurality of central processing units, storage media and input-output interfaces. It advantageously comprises telecommunication means 801 and 803 for communicating with the acquiring and adjusting modules. A display device 804 equipped with a graphical interface and in communication with the computer 802 may be advantageous for displaying information to an operator.

FIG. 9 shows in the form of a chart a process for manufacturing a planar substrate comprising a coating heat treated by juxtaposable laser lines forming a continuous overall laser line.

The process for manufacturing a planar substrate comprising a coating heat treated by a plurality i of juxtaposable laser lines in order to form a continuous overall laser line suitable for heat treating the planar substrate capable of being made to move rectilinearly in a first direction, each laser line being formed by a module that emits a laser line onto the surface S of the planar substrate, on which surface the heat treatment is carried out, comprises:
a. a step E900 in which a planar substrate comprising a coating capable of being heat treated is provided;
b. a step E200 of acquiring, for each laser line:
   the values of the coordinates Xᵢ, Yᵢ, Zᵢ of the centre of the laser line, the axes X and Y being located in the plane of the surface S, the axis X corresponding to said first direction, the axis Y corresponding to a second direction perpendicular to the first, and the axis Z corresponding to a third direction perpendicular to the plane of the surface S;
   the values of the coordinates Uᵢ, Vᵢ, Wᵢ, corresponding to the angles made by the laser line to the axes X, Y, Z, respectively;
c. a step E201 of computing, with a computer, the intensity profile Iᵢ=f(X(′)ᵢ, Y(′)ᵢ, Z(′)ᵢ, U(′)ᵢ, V(′)ᵢ, W(′)ᵢ) in two dimensions X, Y projected into the plane Z=0 for each laser line depending on the coordinates Xᵢ, Yᵢ, Zᵢ, Uᵢ, Vᵢ, Wᵢ using an intensity function defined beforehand;
d. a step E202 of computing, with a computer, the linear-power-density profile P_{G} corresponding to the sum of the intensities Iᵢ integrated along the axis X for every point along the axis Y;
e. a step E203 of computing, with a computer, the width profile E corresponding to the full width at half maximum E=LMH(Iᵢ) of each of the intensity profiles Iᵢ along the axis X for every point along the axis Y;
f. a step E204 of comparing, with a computer, the values of the linear-power-density profile P_{G} and of the width profile E to two target values defined beforehand, σ_{P} and σ_{E}, respectively;
g. iterating I206 steps b to e with a new set of values X′ᵢ, Y′ᵢ, Z′ᵢ, U′ᵢ, V′ᵢ, W′ᵢ E205 defined so that in each iteration the values of the linear-power-density profile P_{G} and of the width profile E converge toward the target values σ_{P} and σ_{E}, respectively;
h. a step E206 of adjusting each of the i modules depending on the set of values X′ᵢ, Y′ᵢ, Z′ᵢ, U′ᵢ, V′ᵢ, W′ᵢ thus obtained;
i. a step E901 of heat treating the coating using the continuous overall line formed by the laser lines thus aligned.

FIG. 10 is a graphical representation, in the form of a chart, of the simulating method of the invention. The method for simulating the alignment of a plurality i of juxtaposable laser lines in order to form a continuous overall laser line comprises:
a. a step E11000 of simulating a plurality i of modules each emitting a laser line onto the surface S of a planar substrate capable of being made to move rectilinearly in a first direction;
b. a step E1001 of generating, for each laser line,
   the values of the coordinates Xᵢ, Yᵢ, Zᵢ of the centre of the laser line, the axes X and Y being located in the plane of the surface S, the axis X corresponding to said first direction, the axis Y corresponding to a second direction perpendicular to the first, and the axis Z corresponding to a third direction perpendicular to the plane of the surface S;
   the values of the coordinates Uᵢ, Vᵢ, Wᵢ, corresponding to the angles of rotation of the laser line about the axes X, Y, Z, respectively;
   each of the values of the coordinates Xᵢ, Yᵢ, Zᵢ, Uᵢ, Vᵢ, Wᵢ being generated randomly in an interval of values defined beforehand;
c. a step E201 of computing, with a computer, the intensity profile I=f(X(′)ᵢ, Y(′)ᵢ, Z(′)ᵢ, U(′)ᵢ, V(′)ᵢ, W(′)ᵢ) in two dimensions X, Y projected into the plane Z=0 for each laser line depending on the coordinates Xᵢ, Yᵢ, Zᵢ, Uᵢ, Vᵢ, Wᵢ using an intensity function defined beforehand;
d. a step E202 of computing, with a computer, the linear-power-density profile P_{G} corresponding to the sum of the intensities Iᵢ integrated along the axis X for every point along the axis Y;
e. a step E203 of computing, with a computer, the width profile E corresponding to the full width at half maximum E=LMH(Iᵢ) of each of the intensity profiles Iᵢ along the axis X for every point along the axis Y;
f. a step E204 of comparing, with a computer, the values of the linear-power-density profile P_{G} and of the width profile E to two target values defined beforehand, σ_{P} and σ_{E}, respectively;
g. iterating I206 steps b to e with a new set of values X′ᵢ, Y′ᵢ, Z′ᵢ, U′ᵢ, V′ᵢ, W′ᵢ E205 defined so that in each iteration the values of the linear-power-density profile P_{G} and of the width profile E converge toward the target values σ_{P} and σ_{E}, respectively;
h. a step E1002 of graphically representing the continuous overall laser line thus simulated.

FIG. 11 is a graphical representation of the four laser lines of FIG. 3 and of the power and width profiles P_{G} and E for every point along the axis Y after an alignment using the aligning method of the invention. The four juxtaposable laser lines 150a-d are aligned on the planar substrate 102. The linear-power-density profile P_{G}ΣᵢIᵢ 400 of the intensities Iᵢ along the axis X for every point along the axis Y is located in the middle of the horizontal lines 401a and 401b representing the thresholds at 5% around the target value σ_{P}, which is set to 1. The width profile E 500 along the axis X for every point along the axis Y is located in the middle of the horizontal lines 501a and 501b representing the thresholds at 10% about the target value σ_{E}.

### Example

Four juxtaposable laser lines were aligned according to the aligning method of the invention. The length of each laser line was 400 mm. FIG. 3 shows these four unaligned lines on a planar substrate.

The surface of the substrate represents the plane XY of the coordinate system X, Y, Z. The origin of the axes X and Y is indicated in FIG. 3. The origin of the axis Z is on the surface of the substrate. The coordinates Xᵢ, Yᵢ, Zᵢ, Uᵢ, Vᵢ, Wᵢ of each of the laser lines 105a-105d before alignment are given in table 1 below. The choice of the origin of the coordinate system is a question of convention and depends on the configuration of the installation in which the aligning method is implemented. In the present example, the origin is arbitrarily defined.

FIGS. 4 and 7 respectively show the power and width profiles P_{G} and E for all of the four laser lines and every point along the axis Y. The intensity profile Iᵢ of each of the laser lines is calculated using the flat-top function:

$$I ( x , y , z ) = \frac{\sqrt{π}}{\sqrt{2} {w}_{0} \sqrt{1 + {( \frac{z}{{Z}_{R}} )}^{2}}} \frac{1}{1 + {e}^{( \vert y \vert - l ) / a}} {e}^{- \frac{2 {( x - {F}_{0} ( y ) )}^{2}}{{w}_{0}^{2} ( 1 + {( \frac{z}{{Z}_{R}} )}^{2} )}}$$

The length of the peak, l, is set to 400 mm, the steepness of the edges, a, is 5.5 and the minimum width of the beam w₀ is 60 μm. The quantity Z_{R} is the Rayleigh length. It is computed using the relationship

$${Z}_{R} = \frac{π {w}_{0}^{2}}{λ {M}^{2}}$$

where λ is the wavelength of the laser beam, and M² is a factor characterizing the divergence of the beam. The factor M² is characteristic of the laser line. The values of A and M² are 1.00 μm and 2.5, respectively.

The shape function F₀ is a polynomial Bezier curve defined by four control points. Two control points correspond to the two ends of the laser line, and the two other control points are randomly chosen to lie at a distance from each end respectively comprised between 10% and 20% of the total length, and at an angle with respect to the axis of the line comprised between −0.1° and +0.1°.

For each laser line, the intensity profile Iᵢ is simply obtained by calculating the function I(x′, y′, z′) where x′, y′, z′ are the spatial coordinates obtained after transformation according to the formula:

$$( \begin{matrix}{x}^{′} \\ {y}^{′} \\ {z}^{′}\end{matrix} ) = R ( \begin{matrix}x \\ y \\ z\end{matrix} ) + T$$

Where T is the translation matrix defined by

$$T = ( \begin{matrix}{X}_{i} \\ {Y}_{i} \\ {Z}_{i}\end{matrix} )$$

and R is the translation matrix R=R_{X}(Uᵢ)R_{Y}(Vᵢ)R_{Z}(Wᵢ) in which R_{X}, R_{Y} and R_{Z} are the rotation matrices about the axes of the coordinate system X, Y, Z for the Euler angles Uᵢ, Vᵢ, Wᵢ, respectively.

Each intensity profile Iᵢ was normalized to 1 in order to simplify the computation of the power profiles P_{G}.

The target values σ_{P} and σ_{L} for the linear-power-density profile P_{G} and the width profile L are set to 1.0 and 60 μm, respectively. The tolerance thresholds are 5% and 10% respectively.

The coordinates after alignment are indicated in table 1. The continuous overall laser line, the power profile P_{G} along the axis X for every point along the axis Y and the width profile L along the axis X for any point along the axis Y are graphically shown in FIG. 12.

This example clearly shows that the aligning method of the invention allows a set of juxtaposable laser lines to be aligned so as to form a continuous overall line with a linear-power-density profile P_{G} and width profile E that are constant for every point along the axis Y according to the target values σ_{P} and σ_{E} defined beforehand in the interval of the tolerance thresholds.

TABLE 1

| | | | |
|---|---|---|---|
| 105a | 105b | 105c | 105d |

Before alignment

| | | | | |
|---|---|---|---|---|
| X(mm) | 0.1 | 0.03 | −0.06 | 0.01 |
| Y(mm) | 204.7 | 600.37 | 1000.42 | 1396.83 |
| Z(mm) | −7.85 | −5.96 | −7.73 | −6.74 |
| U(°) | 0.04 | 0.07 | −0.18 | −0.05 |
| V(°) | 0 | 0 | 0 | 0 |
| W(°) | −0.03 | 0.04 | −0.03 | −0.01 |

After alignment

| | | | | |
|---|---|---|---|---|
| X(mm) | 0.11 | 0.17 | 0.11 | 0.13 |
| Y(mm) | 204.7 | 604.87 | 1004.58 | 1404.33 |
| Z(mm) | 0.05 | −0.06 | −0.03 | −0.04 |
| U(°) | 0 | −0.01 | 0.02 | 0.01 |
| V(°) | 0 | 0 | 0 | 0 |
| W(°) | 0 | 0 | 0 | 0 |

1. A method for aligning a plurality i of juxtaposable laser lines in order to form a continuous overall laser line suitable for heat treating a planar substrate capable of being made to move rectilinearly in a first direction, each laser line being formed by a module that emits a laser line onto the surface S of the planar substrate, on which surface a heat treatment is capable of being carried out, said method comprising the following steps:
a. acquiring, for each laser line:
the values of the coordinates Xᵢ, Yᵢ, Zᵢ of the centre of the laser line, the axes X and Y being located in the plane of the surface S, the axis X corresponding to said first direction, the axis Y corresponding to a second direction perpendicular to the first direction, and the axis Z corresponding to a third direction perpendicular to the plane of the surface S;
the values of the coordinates Uᵢ, Vᵢ, Wᵢ, corresponding to the angles made by the laser line to the axes X, Y, Z, respectively;
b. computing, with a computer, the intensity profile Iᵢ for each laser line depending on the coordinates Xᵢ, Yᵢ, Zᵢ, Uᵢ, Vᵢ, Wᵢ using an intensity function defined beforehand;
c. computing, with a computer, the linear-power-density profile P_{G} corresponding to the sum of the intensities Iᵢ integrated along the axis X for every point along the axis Y;
d. computing, with a computer, the width profile E corresponding to the width of the sum of the intensity profiles Iᵢ along the axis X for every point along the axis Y;
e. comparing, with a computer, the values of the linear-power-density profile P_{G} and of the width profile E to two target values defined beforehand, σ_{P} and σ_{E}, respectively;
f. iterating steps b to e with a new set of values X′ᵢ, Y′ᵢ, Z′ᵢ, U′ᵢ, V′ᵢ, W′ᵢ defined so that in each iteration the values of the intensity profile P_{G} and of the width profile E converge toward the target values σ_{P} and σ_{E}, respectively;
g. adjusting each of the i modules depending on the set of values X′ᵢ, Y′ᵢ, Z′ᵢ, U′ᵢ, V′ᵢ, W′ᵢ thus obtained.

2. The aligning method as claimed in claim 1, wherein the intensity function for the computation of the intensity profile Iᵢ, for each laser line, is a function of Gaussian profile.

3. The aligning method as claimed in claim 1, wherein the intensity function for the computation of the intensity profile Iᵢ, for each laser line, is a function of flat-top profile.

4. The aligning method as claimed in claim 3, wherein the function of flat-top profile comprises, as parameters, a minimum beam width comprised between 10 μm and 500 μm, a flat-top length comprised between 1 cm and 300 cm and an edge steepness comprised between 1 mm and 10 mm.

5. The aligning method as claimed in claim 1, wherein the width of each of the intensity profiles Iᵢ along the axis X is the full width at half maximum.

6. The aligning method as claimed in claim 1, that wherein the intensity function comprises a shape function modeling the geometric shape of the laser line.

7. The aligning method as claimed in claim 6, wherein the shape function is a polynomial Bezier curve defined by at least four control points, two of the four of which points correspond to the two ends of the laser line.

8. The aligning method as claimed in claim 7, wherein the polynomial Bezier curve comprises four control points, two control points of which are randomly chosen to lie at a distance from each end respectively comprised between 10% and 20% of the total length, and at an angle with respect to the axis of the line comprised between −0.1° and +0.1°.

9. The aligning method as claimed in claim 1, wherein the values X′ᵢ, Y′ᵢ, Z′ᵢ, U′ᵢ, V′ᵢ, W′ᵢ of step f are defined using the least-squares method.

10. A computer program containing instructions for executing the steps of a method as claimed in claim 1.

11. A non-transitory computer-readable storage medium on which a computer program containing instructions for executing the steps of a method as claimed in claim 1 is stored.

12. A device for aligning a plurality i of juxtaposable laser lines in order to form a continuous overall laser line suitable for heat treating a planar substrate capable of being made to move rectilinearly in a first direction, each laser line being formed by a module that emits a laser line onto the surface S of a planar substrate, on which surface a heat treatment is capable of being carried out, said device comprising the following modules:
a. a module for acquiring, for each laser line:
values of the coordinates Xᵢ, Yᵢ, Zᵢ of the centre of the laser line, the axes X and Y being located in the plane of the surface S, the axis X corresponding to said first direction, the axis Y corresponding to a second direction perpendicular to the first direction, and the axis Z corresponding to a third direction perpendicular to the plane of the surface S;
values of the coordinates Uᵢ, Vᵢ, Wᵢ, corresponding to the angles of rotation of the laser line about the axes X, Y, Z, respectively;
b. a module for computing the intensity profile Iᵢ for each laser line depending on the coordinates Xᵢ, Yᵢ, Zᵢ, Uᵢ, Vᵢ, Wt using an intensity function defined beforehand;
c. a module for computing the linear-power-density profile P_{G} corresponding to the sum of the intensities Iᵢ integrated along the axis X for every point along the axis Y;
d. a module for computing the width profile E corresponding to the width of each of the intensity profiles Iᵢ along the axis X for every point along the axis Y;
e. a module for comparing the values of the linear-power-density profile P_{G} and of the width profile E to two target values defined beforehand, σ_{P} and σ_{E}, respectively;
f. a module for adjusting each of the i modules depending on the set of values X′ᵢ, Y′ᵢ, Z′ᵢ, U′ᵢ, V′ᵢ, W′ᵢ thus obtained.

13. The aligning device as claimed in claim 12, further comprising an observing device that is movable along the axis Y being arranged in the place of the planar substrate so that a focal plane of the observing device corresponds to the plane that would be defined by the surface S of said planar substrate if it was present.

14. The aligning device as claimed in claim 13, further comprising a module for graphically displaying the power and width profiles P_{G} and E.

15. A process for manufacturing a planar substrate comprising a coating heat treated with juxtaposable laser lines forming a continuous overall laser line, said process comprising:
i) a step in which a planar substrate comprising a coating capable of being heat treated is provided;
ii) a step of aligning the juxtaposable laser lines using a method as claimed in claim 1; and
iii) a step of heat treating the coating using the continuous overall line formed by the laser lines thus aligned.

16. A method for simulating alignment of a plurality i of juxtaposable laser lines in order to form a continuous overall laser line, the method comprising:
a. a step of simulating a plurality i of modules each emitting a laser line onto the surface S of a planar substrate capable of being made to move rectilinearly in a first direction;
b. a step of generating, for each laser line,
the values of the coordinates Xᵢ, Yᵢ, Zᵢ of the centre of the laser line, the axes X and Y being located in the plane of the surface S, the axis X corresponding to said first direction, the axis Y corresponding to a second direction perpendicular to the first, and the axis Z corresponding to a third direction perpendicular to the plane of the surface S;
the values of the coordinates Uᵢ, Vᵢ, Wᵢ, corresponding to the angles of rotation of the laser line about the axes X, Y, Z, respectively;
each of the values of the coordinates Xᵢ, Yᵢ, Zᵢ, Uᵢ, Vᵢ, Wᵢ being generated randomly in an interval of values defined beforehand;
c. a step of aligning the juxtaposable laser lines using a method as claimed in claim 1;
d. a step of graphically representing the continuous overall laser line thus simulated.

17. A device for simulating alignment of a plurality i of juxtaposable laser lines in order to form a continuous overall laser line, comprising:
a. a module for simulating a plurality i of modules each emitting a laser line onto the surface S of a planar substrate capable of being made to move rectilinearly in a first direction;
b. a module for generating, for each laser line,
the values of the coordinates Xᵢ, Yᵢ, Zᵢ of the centre of the laser line, the axes X and Y being located in the plane of the surface S, the axis X corresponding to said first direction, the axis Y corresponding to a second direction perpendicular to the first direction, and the axis Z corresponding to a third direction perpendicular to the plane of the surface S;
the values of the coordinates Uᵢ, Vᵢ, Wᵢ, corresponding to the angles of rotation of the laser line about the axes X, Y, Z, respectively;
each of the values of the coordinates Xᵢ, Yᵢ, Zᵢ, Uᵢ, Vᵢ, Wᵢ being generated randomly in an interval of values defined beforehand;
c. a device for aligning the juxtaposable laser lines using a method as claimed in claim 1;
d. a module for graphically representing the continuous overall laser line thus simulated.
